(19) United States
(12) Patent Application Publication
(10) Pub. No.: US 2023/0264437 A1
(43) Pub. Date: Aug. 24, 2023

(54) MULTI-COMPONENT REINFORCED VEHICLE PART FORMING DEVICE

(71) Applicant: GM Global Technology Operations LLC, Detroit, MI (US)

(72) Inventors: Brian V. Castillo, Birmingham, MI (US); Joshua Lee Solomon, Berkley, MI (US); James W. Wells, Rochester Hills, MI (US)

(21) Appl. No.: 17/676,990

(22) Filed: Feb. 22, 2022

(51) Int. Cl. B29C 70/54; B29C 33/38

(52) U.S. Cl. CPC B29C 70/54; B29C 33/3842; B29K 2905/00

(57) ABSTRACT

A multi-component reinforced part forming device includes a forming member having a first side including a wear surface defining a part-shaped cavity, an opposing second side including a protrusion corresponding to the part-shaped cavity, and a peripheral edge. A frame extends about the peripheral edge. The frame includes a first edge arranged adjacent the wear surface and a second edge spaced from the opposing second side. The frame and the opposing second side define a void. A plurality of reinforcing members is arranged in the void. A first number of the plurality of reinforcing members supports the opposing second side and a second number of the plurality of reinforcing members supports the protrusion. An amount of reinforcing backing material is disposed in the void.

### INTRODUCTION

The subject disclosure relates to the art of manufacturing and, more particularly, to a multi-component reinforced part forming device.

Many vehicle parts are created through stamping, vacuum forming, molding and the like. Creating a stamping die or mold to form parts is a time consuming and very costly process. A stamping die can cost upwards of a million dollars or more. Typically, a stamping die is formed by subtraction. For example, a block of metal is milled, machined, and drilled to form a desired shape. Once the desired shape in formed, a polishing process is initiated. The subtraction process is time consuming and very wasteful.

Other part forming devices, injection molds, vacuum forming molds and the like are equally costly, time consuming to produce and result in a significant amount of wasted material. The need to reduce tooling investment in manufacturing automobiles is a long standing problem. In particular, there is a need to reduce tooling investment for limited vehicle runs in order to maintain vehicle cost at an obtainable level while, at the same time, generating profit for a manufacturer. Accordingly, the industry would welcome a low cost, readily manufacturable, part forming device for vehicle fabrication.

### SUMMARY

A multi-component reinforced part forming device in accordance with a non-limiting example includes a forming member having a first side including a wear surface defining a part-shaped cavity, an opposing second side including a protrusion corresponding to the part-shaped cavity, and a peripheral edge. A frame extends about the peripheral edge. The frame includes a first edge arranged adjacent the wear surface and a second edge spaced from the opposing second side. The frame and the opposing second side define a void. A plurality of reinforcing members is arranged in the void. A first number portion of the plurality of reinforcing members supports the opposing second side and a second number of the plurality of reinforcing members supports the protrusion. An amount of reinforcing backing material is disposed in the void.

In addition to one or more of the features described above or below, or as an alternative, further embodiments could include wherein the plurality of reinforcing members form a three-dimensional (3D) lattice.

In addition to one or more of the features described above or below, or as an alternative, further embodiments could include wherein the forming member includes a first portion defining the part-shaped cavity and a second portion defining a substantially planar surface having the first side and the second side.

In addition to one or more of the features described above or below, or as an alternative, further embodiments could include wherein the second portion includes a part feature that extends into the part-shaped cavity.

In addition to one or more of the features described above or below, or as an alternative, further embodiments could include a raised element mounted in the part-shaped cavity.

In addition to one or more of the features described above or below, or as an alternative, further embodiments could include wherein the part-shaped cavity includes an opening, the raised element being mounted in the part-shaped cavity in the opening.

In addition to one or more of the features described above or below, or as an alternative, further embodiments could include wherein the forming member is formed from sheet metal.

In addition to one or more of the features described above or below, or as an alternative, further embodiments could include wherein the first portion is mechanically connected to the second portion.

In addition to one or more of the features described above or below, or as an alternative, further embodiments could include wherein the first portion is chemically connected to the second portion.

In addition to one or more of the features described above or below, or as an alternative, further embodiments could include wherein the amount of reinforcing backing material comprises a volumetrically stable material.

In addition to one or more of the features described above or below, or as an alternative, further embodiments could include wherein the volumetrically stable material comprises epoxy resin.

In addition to one or more of the features described above or below, or as an alternative, further embodiments could include wherein the volumetrically stable material comprises cementitious grout.

In addition to one or more of the features described above or below, or as an alternative, further embodiments could include wherein the volumetrically stable material comprises a Kirksite casting alloy.

In addition to one or more of the features described above or below, or as an alternative, further embodiments could include wherein the plurality of reinforcing members is bonded to the forming member.

A method of forming a multi-component reinforced part forming device in accordance with a non-limiting example includes creating a forming member having a wear surface including a part-shaped cavity and an opposing surface including a protrusion corresponding to the part-shaped cavity, connecting a plurality of reinforcing members to form a reinforcing lattice, joining the reinforcing lattice to the opposing surface and the protrusion, creating a frame about the forming member and the reinforcing lattice, and supporting the forming member and reinforcing lattice with a reinforcing backing material.

In addition to one or more of the features described above or below, or as an alternative, further embodiments could include wherein creating the forming member includes bending a piece of sheet metal to form the part-shaped cavity.

In addition to one or more of the features described above or below, or as an alternative, further embodiments could include wherein creating the forming member includes forming a member having a substantially planar surface including a part feature that extends into the part-shaped cavity.

In addition to one or more of the features described above or below, or as an alternative, further embodiments could include wherein creating the forming member includes joining the member having the substantially planar surface to the piece of sheet metal.

In addition to one or more of the features described above or below, or as an alternative, further embodiments could include polishing the member including the substantially planar surface and the piece of sheet metal to smooth joints and eliminate imperfections.

In addition to one or more of the features described above or below, or as an alternative, further embodiments could include creating a design in the wear surface of the part-shaped cavity.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a perspective view of a multi-component reinforced part forming device, in accordance with a non-limiting example;

FIG. 2 is a perspective view of a first portion of a forming member of the multi-component reinforced part forming device, in accordance with a non-limiting example;

FIG. 3 is a perspective view of a second portion of the forming member of the multi-component reinforced part forming device, in accordance with a non-limiting example;

FIG. 4 is a perspective view of a raised element of the multi-component reinforced part forming device, in accordance with a non-limiting example;

FIG. 5 is a perspective view of a first surface of the first portion and the second portion joined to form a forming member of the multi-component reinforced part forming device, in accordance with a non-limiting example;

FIG. 6 is a perspective view of a second, opposing surface of the forming member of FIG. 5, in accordance with a non-limiting example;

FIG. 7 is a perspective view of the forming member of FIG. 5 following a polishing operation, in accordance with a non-limiting example;

FIG. 8 is perspective view of the second, opposing surface of the forming member including a plurality of reinforcing members forming a three-dimensional lattice, in accordance with a non-limiting example;

FIG. 9 is a perspective view of the forming member and three-dimensional lattice surrounded by a frame and supported by an amount of reinforcing backing material, in accordance with a non-limiting example;

FIG. 10 depicts the forming member of FIG. 9 including a volumetrically stable backing material supporting the three-dimensional lattice;

FIG. 11 depicts embellishments formed on wear surfaces of a part-shaped cavity of the forming member, in accordance with a non-limiting example; and

FIG. 12 depicts a flow chart illustrating a method of creating a multi-component reinforced part forming device, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

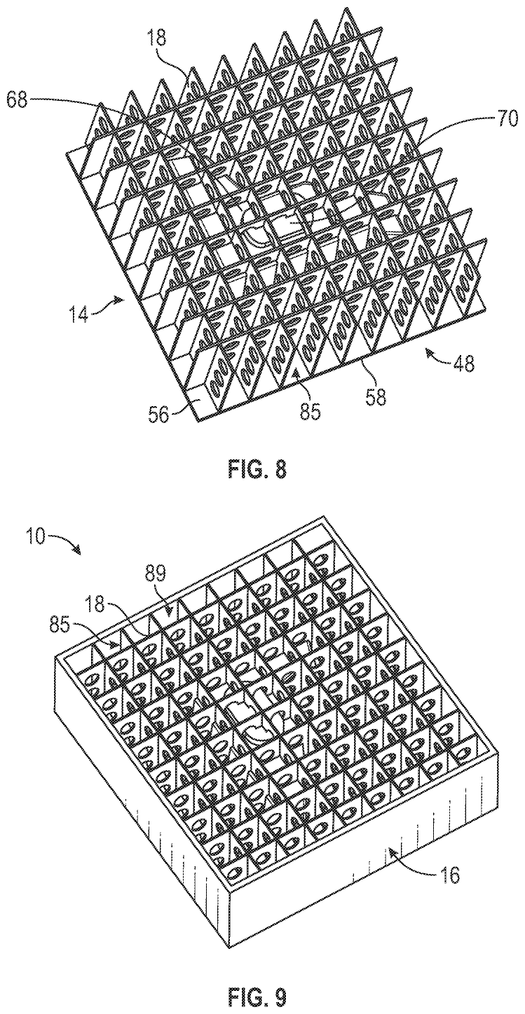

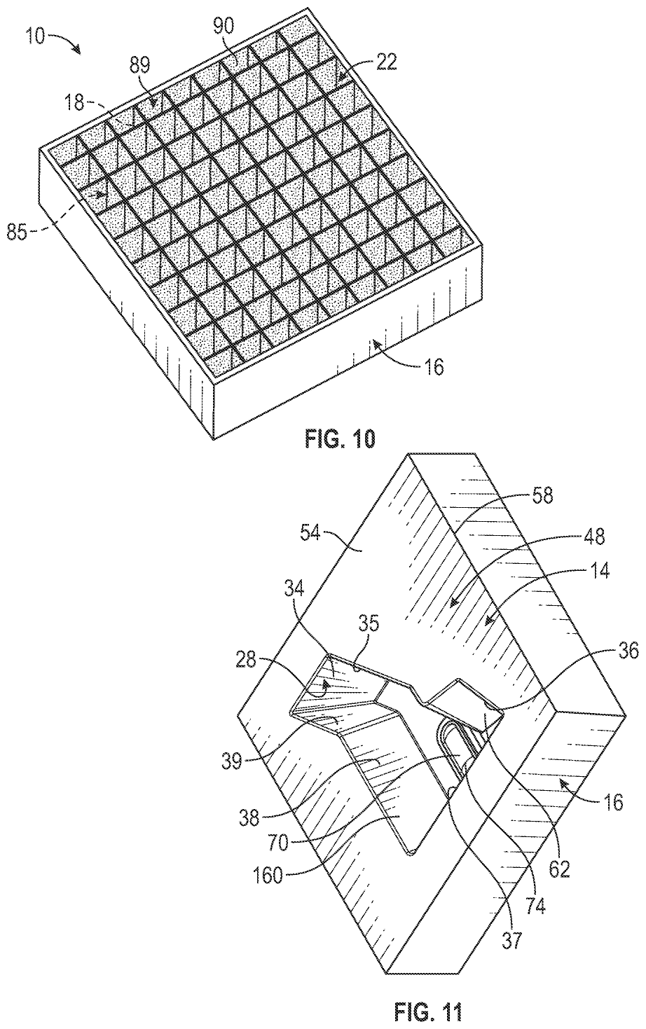

A multi-component reinforced part forming device is indicated generally at 10 in FIG. 1 in accordance with a non-limiting example. Multi-component reinforced part forming device 10 includes a forming member 14 supported by a frame 16 and supported by a plurality of reinforcing members 18 (FIG. 8). Reinforcing members 18 are further supported by an amount of volumetrically stable reinforcing backing material 22 (FIG. 10). As will be detailed herein, multi-component reinforced vehicle part forming device 10 may be used as a stamping die, a vacuum forming mold, an injection mold or the like so as to form a component for a vehicle. At this point, it should be understood that while described in terms of forming a vehicle component, the part forming device in accordance with non-limiting examples may be used to form a wide array of components in various industries.

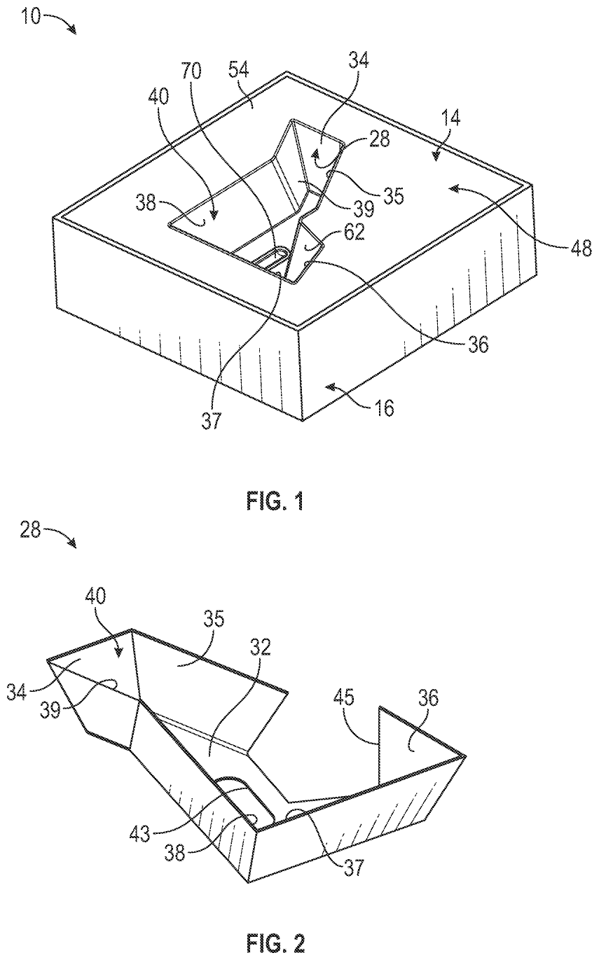

In a non-limiting example depicted in FIG. 2 and with continuing reference to FIG. 1, forming member 14 includes a first portion 28 having a base portion 32 and a plurality of wear surfaces 34-39. First portion 28 is a unitized component and may be formed by folding sheet metal or the like. Base portion 32 and the plurality of wear surfaces 34-39 form a portion of a part-shaped cavity 40. Part-shaped cavity 40 possesses a geometry of a vehicle component (not shown). In a non-limiting example, base portion 32 may include an opening 43 and a gap 45 may exist between select adjacent ones of wear surfaces 34-39. In the non-limiting example shown, gap 45 is disposed between wear surface 35 and wear surface 36.

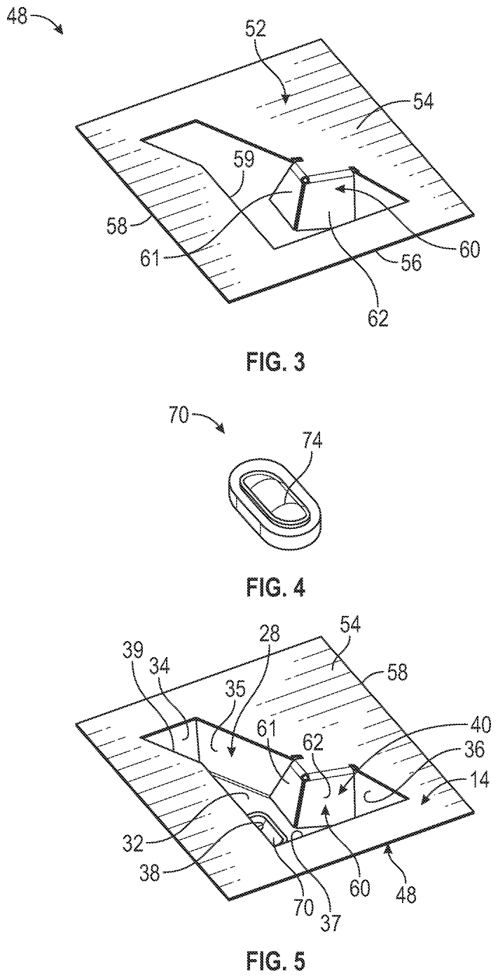

In a non-limiting example depicted in FIG. 3, forming member 14 also includes a second portion 48 that, as will be detailed more fully herein, is joined to first portion 28. In a non-limiting example, second portion 48 includes a planar surface 52 having a first side 54, a second side 56 that is opposite first side 54, an outer peripheral edge 58 and an inner peripheral edge 59 defining an opening (not separately labeled) which corresponds to first portion 28. A part feature 60 projects outward of inner peripheral edge 59.

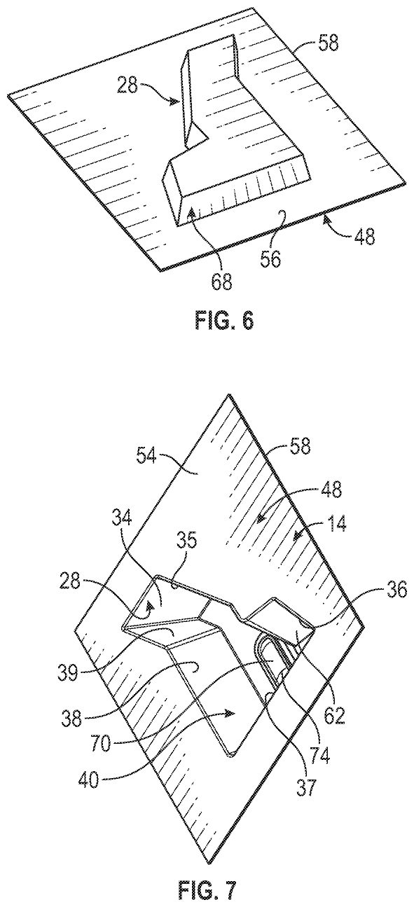

Second portion 48 is a unitized member formed from a single piece of material such as sheet metal. When first portion 28 is joined to second portion 48, part feature 60 nests with gap 45 and forms two additional wear surfaces 61 and 62. First portion 28 also creates a protrusion 68 that extends outward from second side 56 as shown in FIG. 6. In a non-limiting example, a raised element 70, such as depicted in FIG. 4, may be incorporated into first portion 28. More specifically, raised element 70 may take the form of an additively manufactured component 74 which, when installed in opening 43 creates a feature such as a boss or the like in base portion 32.

In a non-limiting example, first portion 28 is joined to second portion 48 as shown in FIGS. 5 and 6. When joined, a plurality of seams (not separately labeled) are formed at an interface of wear surfaces 34-39 and inner peripheral edge 59. Additional seams (also not separately labeled) are formed at an interface between part feature 60 and wear surfaces 35, 36. In order to improve a surface finish of any part formed by multi-component reinforced part forming device 10, first portion 28 and second portion 48 undergo a polishing process such that all seams are smoothed out as shown in FIG. 7. Various processes may be used to join first portion 28 and second portion 48 including chemical joining processes such as welding, and mechanical joining processes such as soldering, adhesive bonding, and the like. It should also be understood that first portion 28 and second portion 48 may be formed as a unitary member through, for example, additive manufacturing, stamping, and the like.

After completing forming member 14, the plurality of reinforcing members 18 are connected to form a three-dimensional (3D) lattice 85 and joined to second side 56 and protrusion 68 as shown in FIG. 8. At this point, frame 16 is connected to outer peripheral edge 58 as shown in FIG. 9. Frame 16 extends about and encloses an outer periphery of 3D lattice 85 forming a void 89 having a plurality of fluidically interconnected cells (not separately labeled). The fluidically interconnected cells are created by 3D lattice 85. At this point, the amount of volumetrically stable material 90 is introduced into void 89 and allowed to flow through the plurality of fluidically connected cells and hardened forming the volumetrically stable reinforcing backing material 22 as shown in FIG. 10. Volumetrically stable material 90 can take on a variety of forms including epoxy resin, filled epoxy resin having a mineral or metallic filler, cementitious grout, a Kirksite casting alloy and the like. It should be understood that the term “volumetrically stable” refers to a property of the material to maintain it's volume when in a fluid form as well as after hardening.

At this point, it should be appreciated that the multi-component reinforced part forming device such as shown in FIG. 11 represents a low cost, readily manufactured with a shorter lead time, mold, or die that, depending on how the part forming device is implemented, may be used to form a vehicle part through one of a variety of part forming techniques including die stamping, injection molding, vacuum forming and the like. The part forming device may replace more expensive molds and dies, in particular, for the construction of low volume vehicles in which tool investment costs are of a concern.

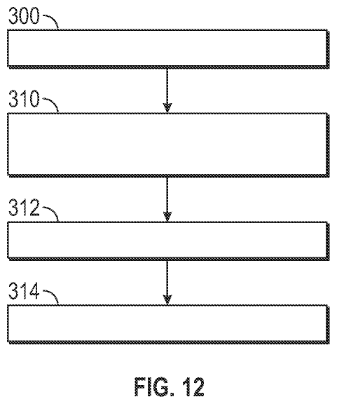

Multi-component reinforced part forming device 10 may be created through a variety of processes such as in FIG. 12. For example, forming member 14 is created as shown at 300 in FIG. 12. Creating forming member 14 may include a variety of steps including joining steps, shaping steps, polishing steps and the like. After creating forming member 14, reinforcing members 18 may be added in block 310 followed by frame 16 in block 312. At this point, it should be clear that frame 16 may be added before reinforcing members 18. Volumetrically stable material 90 may be added in block 314 to support and stabilizes reinforcing members 18.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A multi-component reinforced part forming device comprising:
a forming member having a first side including a wear surface defining a part-shaped cavity, an opposing second side including a protrusion corresponding to the part-shaped cavity, and a peripheral edge;
a frame extending about the peripheral edge, the frame including a first edge arranged adjacent the wear surface and a second edge spaced from the opposing second side, the frame and the opposing second side defining a void;
a plurality of reinforcing members arranged in the void, a first number of the plurality of reinforcing members supporting the second side and a second number of the plurality of reinforcing members supporting the protrusion; and
an amount of reinforcing backing material disposed in the void.

2. The multi-component reinforced part forming device according to claim 1, wherein the plurality of reinforcing members form a three-dimensional (3D) lattice.

3. The multi-component reinforced part forming device according to claim 1, wherein the forming member includes a first portion defining the part-shaped cavity and a second portion defining a substantially planar surface having the first side and the second side.

4. The multi-component reinforced part forming device according to claim 3, wherein the second portion includes a part feature that extends into the part-shaped cavity.

5. The multi-component reinforced part forming device according to claim 3, further comprising a raised element mounted in the part-shaped cavity.

6. The multi-component reinforced part forming device according to claim 5, wherein the part-shaped cavity includes an opening, the raised element being mounted in the part-shaped cavity in the opening.

7. The multi-component reinforced part forming device according to claim 3, wherein the forming member is formed from sheet metal.

8. The multi-component reinforced part forming device according to claim 7, wherein the first portion is mechanically connected to the second portion.

9. The multi-component reinforced part forming device according to claim 7, wherein the first portion is chemically connected to the second portion.

10. The multi-component reinforced part forming device according to claim 1, wherein the amount of reinforcing backing material comprises a volumetrically stable material.

11. The multi-component reinforced part forming device according to claim 10, wherein the volumetrically stable material comprises epoxy resin.

12. The multi-component reinforced part forming device according to claim 10, wherein the volumetrically stable material comprises cementitious grout.

13. The multi-component reinforced part forming device according to claim 10, wherein the volumetrically stable material comprises a Kirksite casting alloy.

14. The multi-component reinforced part forming device according to claim 1, wherein the plurality of reinforcing members is bonded to the forming member.

15. A method of forming a multi-component reinforced part forming device comprising:
creating a forming member having a wear surface including a part-shaped cavity and an opposing surface including a protrusion corresponding to the part-shaped cavity;
connecting a plurality of reinforcing members to form a reinforcing lattice;
joining the reinforcing lattice to the opposing surface and the protrusion;
creating a frame about the forming member and the reinforcing lattice; and
supporting the forming member and the reinforcing lattice with a reinforcing backing material.

16. The method of claim 15, wherein creating the forming member includes bending a piece of sheet metal to form the part-shaped cavity.

17. The method of claim 16, wherein creating the forming member includes forming a member having a substantially planar surface including a part feature that extends into the part-shaped cavity.

18. The method of claim 17, wherein creating the forming member includes joining the member having the substantially planar surface to the piece of sheet metal.

19. The method of claim 18, further comprising polishing the member including the substantially planar surface and the piece of sheet metal to smooth joints and eliminate imperfections.

20. The method of claim 15, further comprising creating a design in the wear surface of the part-shaped cavity.
